(19) United States
(12) Patent Application Publication
(10) Pub. No.: US 2014/0329563 A1
(43) Pub. Date: Nov. 6, 2014

(54) INFORMATION PROCESSING METHOD AND SYSTEM, AND RECORDING MEDIUM

(71) Applicant: INFOBANK CORP., Seongnam-si, Gyeonggi-do (KR)

(72) Inventors: Jun ho Jang, Seongnam-si (KR); Tae hyung Park, Seoul (KR); Seong jin Ahn, Seoul (KR); Jong cheol Hong, Seoul (KR)

(21) Appl. No.: 14/366,378

(22) PCT Filed: Dec. 20, 2012
(86) PCT No.: PCT/KR2012/011208

§ 371 Date: Jun. 18, 2014

(30) Foreign Application Priority Data
Dec. 20, 2011 (KR) 10-2011-0137977
Dec. 20, 2011 (KR) 10-2011-0137978
Dec. 20, 2011 (KR) 10-2011-0137980

(51) Int. Cl. H04M 1/60; G10L 15/26; H04M 1/725; G10L 13/04

(52) U.S. Cl. CPC H04M 1/6075; G10L 13/043; G10L 15/265; H04M 1/72569; H04M 1/7253
USPC 455/563

(57) ABSTRACT

The present invention relates to an information processing method and system, and a recording medium, and the information processing system includes a storage medium for storing identification information of a wireless terminal; a checking section for checking whether the wireless terminal is positioned in a vehicle; a converting section for converting text information into speech information on receiving the text information, having the identification information of the wireless terminal as a recipient, in case the wireless terminal is positioned in the vehicle, according to a result of the checking by the checking section; and a processing section for transmitting the converted speech to the wireless terminal.

### TECHNICAL FIELD

The present invention relates to an information processing method and system, and a recording medium for checking whether a wireless terminal is positioned in a vehicle, converting text information transmitted to the wireless terminal into speech information, and converting reply speech information transmitted through the wireless terminal or an in-vehicle communication apparatus into the text information.

### BACKGROUND ART

In recent, with active supply of mobile messengers, prior e-mail applications, SMS (short message service) applications, and various IM (Instant Messenger) applications such as KakaoTalk, etc. has been established as a text information receiving means, and therefore a user has been various kinds of text information receiving means, more than one to two, on a wireless terminal.

However, when the user is driving, various text information receiving means sometimes receive the text information and therefore causes risks due to drivers' gaze dispersion on driving.

On the other hand, with the development of a TTS (Text to Speech) engine for converting the text information into the speech information and a STT (Speech to Text) engine for converting the speech information into the text information, the user outputs the text information received into the wireless terminal into the speech information and may listen to the outputted speech information, and when the user inputs speech information, it is converted into the text information to transmit it.

An apparatus and method for recognizing a user's speech are disclosed in Korea Patent Application Publication No. 10-2001-0086402(Title: speech recognition apparatus), and An apparatus and method for synthesizing specific sentences with random speech are disclosed in Korea Patent Application Publication No. 10-2002-0094988(Title: speech synthesizing method, and speech synthesizing apparatus for embodying the same).

However, although the TTS engine and STT engine are disposed in the wireless terminal, the user drives the TTS engine and STT engine on receiving the text information one by one, and there is a case for forgetting the driving of the TTS engine and STT engine on driving, thereby to become them as titular functions.

### DISCLOSURE OF INVENTION

### Technical Problem

An object of the present invention for solving the above-mentioned problems is providing an information processing method and system, and a computer-readable recording medium for writing programs to execute information processing for solving the inconvenience in that the user rides on a vehicle one by one and directly processes the driving of TTS engine and STT engine and, simultaneously, for fundamentally blocking dangerous situations that attention and action of a driver are focused on the wireless terminal on receiving text information while forgetting the driving of the TTS engine and STT engine on driving by automatically converting the text information into speech information and transmitting it to the wireless terminal, in case the wireless terminal is positioned in the vehicle, after checking whether the wireless terminal is positioned in the vehicle.

### Solution to Problem

According to an aspect of the invention, there is provided an information processing system including a storage medium for storing identification information of a wireless terminal; a checking section for checking whether the wireless terminal is positioned in a vehicle; a converting section for converting text information into speech information on receiving the text information, having the identification information of the wireless terminal as a recipient, in case the wireless terminal is positioned in the vehicle, according to a result of the checking by the checking section; and a processing section for transmitting the converted speech information to the wireless terminal.

According to another aspect of the invention, there is provided an information processing method including checking whether a wireless terminal is positioned in a vehicle; converting text information into speech information on receiving the text information, having the identification information of the wireless terminal as a recipient, in case the wireless terminal is positioned in the vehicle, according to a result of the checking by the checking section; and transmitting the converted speech to the wireless terminal.

According to further another aspect of the invention, there is provided an information processing system including a storage medium for connecting identification information of a user's wireless terminal and the identification information of a communication apparatus disposed in a user's vehicle and storing the connected it; a checking section for checking whether the wireless terminal is positioned in a vehicle; a converting section for converting text information into speech information on receiving the text information, having the identification information of the wireless terminal as a recipient, in case the wireless terminal is positioned in the vehicle, according to a result of the checking by the checking section; and a processing section for processing so that the text information is transmitted to the wireless terminal and the converted speech information is transmitted to a communication apparatus corresponding to the identification information of the communication apparatus connected to the identification information of the wireless terminal checked through the storage medium.

According to further another aspect of the invention, there is provided an information processing method including checking whether a wireless terminal is positioned in a vehicle; converting text information into speech information on receiving the text information, having the identification information of the wireless terminal as a recipient, in case the wireless terminal is positioned in the vehicle, according to a result of the checking by the checking section; and processing so that the text information is transmitted to the wireless terminal and the converted speech information is transmitted to a communication apparatus corresponding to the identification information of the communication apparatus connected to the identification information of the wireless terminal checked through the storage medium connecting and storing the identification information of a user's wireless terminal and the identification information of the communication apparatus disposed in the user's vehicle.

According to further another aspect of the invention, there is provided an information processing system including a storage medium for connecting identification information of a user's wireless terminal and the identification information of a communication apparatus disposed in the user's vehicle and storing the connected it; a checking section for checking whether the wireless terminal is positioned in a vehicle; a converting section for converting text information into speech information on receiving the text information, having the identification information of the wireless terminal as a recipient, in case the wireless terminal is positioned in the vehicle, according to a result of the checking by the checking section; and a processing section for processing so that the converted speech information is transmitted to a communication apparatus corresponding to the identification information of the communication apparatus connected to the identification information of the wireless terminal checked through the storage medium.

According to further another aspect of the invention, there is provided an information processing method including checking whether a wireless terminal is positioned in a vehicle; converting text information into speech information on receiving the text information, having the identification information of the wireless terminal as a recipient, in case the wireless terminal is positioned in the vehicle, according to a result of the checking by the checking section; and processing so that the converted speech information is transmitted to a communication apparatus corresponding to the identification information of the communication apparatus connected to the identification information of the wireless terminal checked through the storage medium connecting and storing the identification information of a user's wireless terminal and the identification information of the communication apparatus disposed in the user's vehicle.

### Advantageous Effects of Invention

According to an embodiment of the present invention, the present invention automatically converts the text information into the speech information and transmits the converted speech information to the wireless terminal after checking whether the wireless terminal is positioned in a vehicle, thereby to solve the inconvenience in that the user rides on the vehicle one by one and directly processes the driving of TTS engine and STT engine and, simultaneously, to fundamentally block dangerous situations that attention and action of a driver are focused on the wireless terminal on receiving the text information while forgetting the driving of the TTS engine and STT engine on driving.

Further, according to another embodiment of the present invention, the present invention outputs the converted speech information through the hands-free apparatus or communication apparatus disposed in the vehicle, not a speaker of the wireless terminal, and receives a user's reply speech information through the hands-free apparatus or communication apparatus disposed in the vehicle, not a microphone of the wireless terminal, thereby to perform smooth services by the wireless terminal in pockets of clothes and to enhance quality of service by using a speaker or microphone having remarkable performance as compared with the speaker or microphone of the wireless terminal.

Further, according to another embodiment of the present invention, the user for the wireless terminal has economic effect that does not install the TTS engine or STT engine for each of various kinds of text information transceiving applications one by one.

### BRIEF DESCRIPTION OF THE DRAWINGS

The following drawing drawings attached to the present specification illustrate an exemplary embodiment of the invention, and serves to further understand the technical idea of the invention along with a detailed description of the invention. Therefore, the invention is not limited to matters described in the drawings.

FIG. 1 shows configurations of the entire communication network according to an embodiment of the present invention.

FIG. 2 shows configurations of an information processing server according to the embodiment of the present invention.

FIG. 3 shows a process for converting and outputting text information to speech information, after checking whether a wireless terminal is located in a vehicle, according to a first embodiment of the present invention.

FIG. 4 shows the process for converting the text information corresponding to already-registered item information into the speech information according to the embodiment of the present invention.

FIG. 5 shows the process for converting and transmitting a user's reply speech information into the text information according to the first embodiment of the present invention.

FIG. 6 shows one example according to the embodiment of the present invention.

FIG. 7 shows the process for converting text the information into the speech information and outputting it, after checking whether the wireless terminal is located in the vehicle, according to a second embodiment of the present invention.

FIG. 8 shows the process for converting the user's reply speech information into the text information and transmitting it according to a second or third embodiment of the present invention.

FIG. 9 shows the process for converting the text information into the speech information and outputting it, after checking whether the wireless terminal is located in the vehicle, according to a third embodiment of the present invention.

### DESCRIPTION OF THE PREFERRED EMBODIMENTS

Hereinabove, although the present invention is described by specific matters such as concrete components, and the like, embodiments, and drawings, they are provided only for assisting in the entire understanding of the present invention. The specified matters and embodiments and drawings such as specific apparatus drawings of the present invention have been disclosed for illustrative purposes, but are not limited thereto, and those skilled in the art will appreciate that various modifications, additions and substitutions are possible from the disclosure in the art to which the present invention belongs. In describing exemplary embodiments of the present invention, well-known functions or constructions will not be described in detail since they may unnecessarily obscure the understanding of the present invention. Further, the terminologies specifically defined in consideration of the configuration and functions of the present invention may be construed in different ways by the intention of users and operators. Therefore, the definitions thereof should be construed based on the contents throughout the specification. Therefore, the definitions thereof should be construed based on the contents throughout the specification.

It will be apparent to those skilled in the art that substitutions, modifications and variations can be made without departing from the spirit and scope of the invention as defined by the appended claims and can also belong to the scope of the invention.

First, a first embodiment of the present invention will be described.

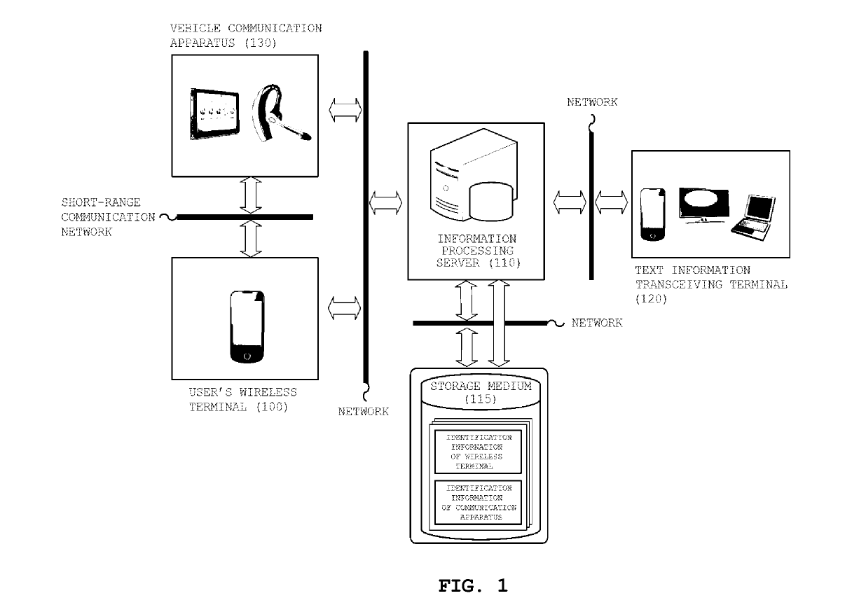

FIG. 1 shows configurations of the entire communication network according to an embodiment of the present invention.

In more detail, FIG. 1 shows the configurations that an information processing system including an information processing server 110 and a storage medium 115 is connected to a user's wireless terminal 100 and a user's vehicle communication apparatus 130 through a communication network, checks whether the wireless terminal 100 is positioned in a vehicle, is connected to a text information transceiving terminal 120 for transmitting text information to the wireless terminal 100 through the communication network, receives the text information transmitted through the text information transceiving terminal 120, and converts the text information into speech information, when the wireless terminal 100 is located in the vehicle, and transmits the converted information to the wireless terminal 100.

The information processing system in an embodiment of the present invention may have various configurations according to the embodiments and communication network connecting schemes.

Firstly, the information processing server 110 is directly connected to the storage medium 115, the information processing server 110 is indirectly connected to the storage medium 115 through the communication network, and the connecting among the information processing server 110, the storage medium 105, the user's wireless terminal 100 and a vehicle communication apparatus 130 may be variously configured by one skilled in the art although not separately shown in the drawing. A key configuration of the information processing system in the present invention, that is, the information processing server 110 receives information for short-range communication connection between the wire terminal 100 and the communication apparatus 130 from the wire terminal 100 or the communication apparatus 130 disposed in the vehicle, or receives signals corresponding to log-in information for the wire terminal 100 from the communication apparatus 130 when the wire terminal 100 is logged into the communication apparatus 130, or receives signals corresponding to the log-in information for the communication apparatus 130 from the wireless terminal 100 when the communication apparatus 130 is logged into the wireless terminal 100, or compares position information of the wireless terminal 100 using GPS (global positioning system) disposed in the wireless terminal 100 with the position information of the communication apparatus 130 using the GPS of the communication apparatus 130 disposed in the vehicle, checks whether the wireless terminal 100 is adjacent to the communication apparatus 130, or directly receives in-vehicle boarding information from the wireless terminal 100, directly receives vehicle boarding information for the wireless terminal 100 from the communication apparatus 130, checks whether the wireless terminal 100 is positioned in the vehicle, converts text information into speech information on receiving the text information transmitted, having identification information (that is, including at least one of number information of the wireless terminal 100, and a user ID information in a text information transceiving application disposed in the wireless terminal 100) for the wireless terminal 100 as a recipient, through the text information transceiving terminal 120, and transmits the converted text information to the wireless terminal 100.

In the present invention, the information processing server 110, on receiving the user's reply speech information through the wireless terminal 100 or the vehicle communication apparatus 130, converts the received speech information into the text information, and further transmits the converted text information to the text information transceiving terminal 120.

The information processing server 110 of the present invention may be a server in a message service center on a communication network when the text information to be received, having the identification information of the wireless terminal 100 as the recipient, is a message including at least one of SMS (Short Message Service), LMS (Long Message Service) and MMS (Multimedia Message Services), may be a E-mail relay server on the communication network when the text information to be received, having the identification information of the wireless terminal 100 as the recipient, is a e-mail, may be a relay server for supplying and operating each messenger application when the text information to be received, having the identification information of the wireless terminal 100 as the recipient, is a message through an instant messenger, and may be a relay server for supplying and operating each messenger application when the text information is the text information to be received into a SNS (Social Networking Service) application.

Although separately not shown separately in the drawings of the present application, the information processing server 110 may be a relay server for each text information corresponding to kinds of the text information and also may be connected to the relay server for each text information included on the communication network through the communication network.

The text information transceiving terminal 120 in the present invention transmits messages including at least one of SMS, LMS, MMS or e-mails to the user's wireless terminal 100, or means a terminal for performing messenger or SNS to the user's wireless terminal 100, and includes all terminals, capable of transmitting and receiving texts, such as a mobile phone, a smartphone, a tablet PC, PC, telematics, etc.

The storage medium 115 in the present invention stores the identification information of the user's wireless terminal 100, and connects the identification information of the user's wireless terminal 100 and the information of the vehicle communication apparatus 130 in some cases and therefore stores the connected it.

The identification information of the wireless terminal 100 of the present invention includes at least one of number information of the wireless terminal 100 and user ID information of the wireless terminal 100 in text information transceiving applications disposed in the wireless terminal 100, and the identification information of the vehicle communication apparatus 130 may include at least one of an inherent ID, an inherent IP address information, user ID information, an inherent number of the communication apparatus 130.

Further, the storage medium 115 may be disposed in the information processing system, or a server on the communication network, or the user's wireless terminal 100, or the vehicle communication apparatus 130.

The user's wireless terminal 100 in the present invention, which is a receiving terminal for the text information transmitted through the text information transceiving terminal 120, receives the speech information corresponding to the text information from the information processing server 110.

In addition, the wireless terminal 100 transmits information for checking whether the wireless terminal 100 is positioned in the vehicle to the information processing server 110, wherein the information for checking whether the wireless terminal 100 is positioned in the vehicle may be at least one of information for short-range communication connection of the vehicle communication apparatus 130, or the log in information of the vehicle communication apparatus 130, or position information of the wireless terminal 100 using GPS (global positioning system) disposed in the wireless terminal 100, or pairing information for a Bluetooth apparatus disposed in the vehicle, or in-vehicle boarding information.

The wireless terminal 100 may output the speech information received from the information processing server 110 through an internal speaker or the vehicle communication apparatus 130 connected through a short-range communication network.

Further, the wireless terminal 100, on inputting the user's reply speech information, also transmits the inputted speech information to the information processing server.

In the present invention, the vehicle communication apparatus 130 transmits information for checking whether the wireless terminal 100 is positioned in the vehicle to the information processing server 110, wherein the information for checking whether the wireless terminal 100 is positioned in the vehicle may be at least one of the information for short-range communication connection of the wireless terminal 100, or the log in information of the wireless terminal 100, or position information of the vehicle communication apparatus 130 using GPS (global positioning system) disposed in the vehicle communication apparatus 130, or pairing information for the Bluetooth apparatus disposed in the vehicle and the wireless terminal 100, or in-vehicle boarding information in the wireless terminal 100.

In the embodiment of the present invention, the vehicle communication apparatus 130 receives and outputs the speech information from the wireless terminal 100 through short-range communication network channels and may transmit the inputted reply speech information to the information processing server 110 via the wireless terminal 100 or directly after receiving the user's reply speech information.

The vehicle communication apparatus 130 of the present invention may include at least one of all apparatuses, capable of performing short-range communication, such as a telematics, an audio apparatus, the Bluetooth apparatus, and a hands-free apparatus disposed in the vehicle.

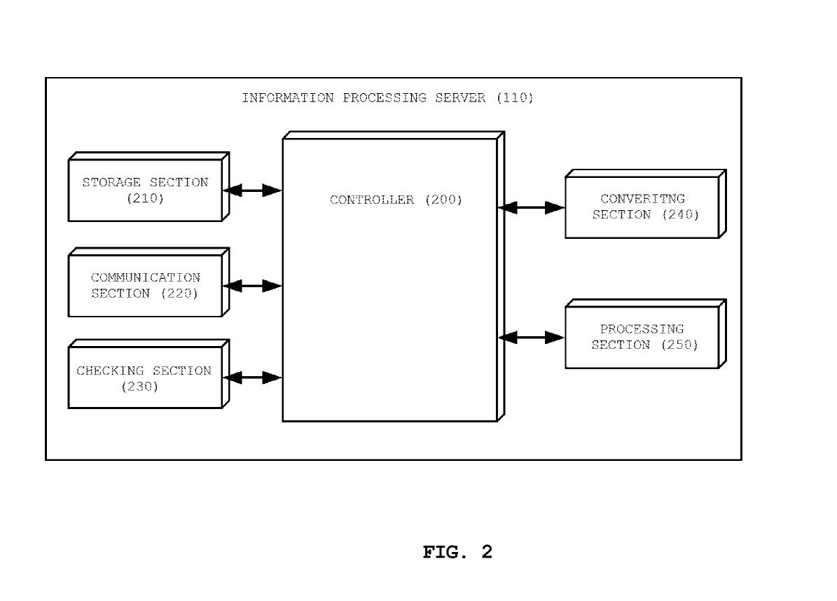

FIG. 2 shows sub-configurations of the information processing server 110 according to an embodiment of the present invention.

FIG. 2 shows sub-configurations of the information processing server 110 on the information processing system shown in FIG. 1, each configuration is to describe an embodiment of the present invention, and the present invention is not limited to the embodiment only shown in FIG. 2.

Referring to FIG. 2, the information processing server 110 in the embodiment of the present invention includes a storage section 210, a communication section 220, a checking section 230, a converting section 240, a processing section 250, and a controller 200 for controlling each configuration mentioned above.
Wherein, the information processing server 110 is shown as a single server in the drawing for the description of the embodiments, but each means or configuration may be separated into at least one server.

Referring to FIG. 2, the storage section 210 stores the identification information of the user's wireless terminal 100 into the storage medium 115.

The storage section 210 of the present invention connects the identification information of the wireless terminal 100 and the vehicle communication apparatus 130 in some cases, and stores the connected it.

Further, the storage section 210 further stores the item information, to be converted into the speech information, of the text information designated by the user or operator for the wireless terminal 100.

Wherein, the item information includes at least one of message transmitter information and message content information in case an application in the wireless terminal 100 receiving the text information is a message transceiving application including at least one of SMS (Short Message Service), LMS (Long Message Service), MMS (Multimedia Message Services), at least one of e-mail transmitter information, e-mail title information and e-mail body content information in case an application in the wireless terminal 100 receiving the text information is an e-mail transceiving application, at least one of messenger user information and messenger content information in case an application in the wireless terminal 100 receiving the text information is an instant messenger application, and at least one of user ID information and content information in case an application in the wireless terminal 100 receiving the text information is a SNS application.

The communication section 220 in the embodiment of the present invention receives information, to check whether the wireless terminal 100 is positioned in the vehicle, from the wireless terminal 100 or the communication apparatus 130 through the communication network, receives the text information from the text information transceiving terminal 120 through the communication network and transmits the text information corresponding to a user's reply to the text information transceiving terminal 120 in some cases, transmits the speech information converting the text information transmitted by the text information transceiving terminal 120 to the wireless terminal 100 through the communication network, and receives a user's reply speech information through the wireless terminal 100 or the vehicle communication apparatus 130 in some cases.

The communication section 220 of the present invention may receive at least one of the information for short-range communication connection of the vehicle communication apparatus 130, the log in information for the vehicle communication apparatus 130, position information of the wireless terminal 100 using GPS (global positioning system) disposed in the wireless terminal 100, the pairing information for the Bluetooth apparatus in the vehicle and the in-vehicle boarding information from the wireless terminal 100, or may receive at least one of the information for short-range communication connection of the wireless terminal 100, the log-in information for the wireless terminal 100, the position information of the vehicle communication apparatus 130 using GPS (global positioning system) disposed in the vehicle communication apparatus 130, the pairing information between the Bluetooth apparatus and the wireless terminal 100 disposed in the vehicle and the in-vehicle boarding information in the wireless terminal 100 from the vehicle communication apparatus 130 on receiving information, to check whether the wireless terminal 100 is positioned in the vehicle, from the wireless terminal 100 or the vehicle communication apparatus 130 through the communication network.

The checking section 230 in the present invention checks whether the wireless terminal 100 is positioned in the vehicle.

In one of the embodiments of the present invention, the checking section 230 receives the information for short-range communication connection between the wireless terminal 100 and the communication apparatus 130 from the wire terminal 100 or the communication apparatus 130 disposed in the vehicle, or receives signals corresponding to the log-in information for the wire terminal 100 from the communication apparatus 130 when the wireless terminal 100 is logged into the communication apparatus 130, or receives signals corresponding to the log-in information for the communication apparatus 130 from the wireless terminal 100 when the communication apparatus 130 is logged into the wireless terminal 100, receives the pairing information between the wireless terminal 100 and the Bluetooth apparatus disposed in the vehicle from the wireless terminal 100 or the vehicle communication apparatus 130 or compares the position information of the wireless terminal 100 using the GPS (global positioning system) disposed in the wireless terminal 100 with the position information of the communication apparatus 130 using the GPS of the communication apparatus 130 disposed in the vehicle, checks whether the wireless terminal 100 is adjacent to the communication apparatus 130, or directly receives the in-vehicle boarding information from the wireless terminal 100, directly receives the vehicle boarding information for the wireless terminal 100 from the communication apparatus 130, and checks whether the wireless terminal 100 is positioned in the vehicle.

The converting section 240 in the present invention converts the text information received by the communication section 220 and being transmitted to the wireless terminal into the speech information.

Further, the converting section 240 converts the received speech information into the text information when the speech information corresponding to a user's reply is received from the wireless terminal 100 or the communication apparatus 130 through the communication section 220 in following processing processes.

According to the present invention, the converting section 240 is shown as a single configuration in the drawing, but a converting section 240(1) for converting the text information into the speech information and a converting section 240(2) for converting the speech information into the text information may be configured separately from each other.

According to the present invention, the converting section 240 may convert texts including emotion represented as various special characters such as “̂̂”, “˜˜”, “);;”, etc. of the text information into the speech information corresponding to the emotion, that is, “haha”, and on the contrary, may convert the speech information, inputted by a user, including “haha” into the text information, that is, “̂̂” including the special character.

The converting section 240 may differ a size of text converted according to a size of speech and the size of the speech according to the size of the received text, on converting emotional expression including such a special character into the speech or text.

In addition, the converting section 240, in case speech characteristic information is included in the text information transmitted from the text information transceiving terminal 120 through the communication section 220 or the speech characteristic information connected to the text information is further received, converts so that speech to be converted is matched with the speech characteristic information with reference to the speech characteristic information on converting the text information into the speech information.

For example, on converting the text information into the speech information in case the speech characteristic information is “Su-Young of girls' generation”, “children”, “grandmother”, etc, the corresponding speech is converted using representative sound quality and speech characteristic for “Su-young of girls' generation”, “children”, “grandmother”.

In this case, the storage section 210 stores various kinds of sound quality and speech characteristic such as “Su-Young of girls' generation”, “children”, “grandmother”, etc into the storage medium 115, and therefore the converting section 240 extracts the sound quality and speech characteristic corresponding to the speech characteristic information from the storage medium 115 and the extracted them are used on converting the text information into the speech information.

Main functions of the converting section 240 of the present invention, that is, a TTS (Text to Speech) function for converting the text information into the speech information and a STT (Speech to Text) function for converting the speech information into the text information uses functions of a prior TTS engine and STT engine or functions of a TTS engine and STT engine to be developed later. Therefore, since they do not become a principal idea of the present invention, the detailed description about them will be omitted.

The processing section 250 transmits the speech information converted through the converting section 240 to the wireless terminal 100 through the communication section 220.

Further, the processing section 250, after converting the speech information corresponding to the user's reply into the text information by the converting section 240, transmits the converted text information to the text information transceiving terminal 120 through the communication section 220.

In the present invention, at least one of functions for each configuration disposed in the information processing server 110 may be implemented by programs to program sets.

Hereinafter, each information processing process in the present invention will be described in more detail.

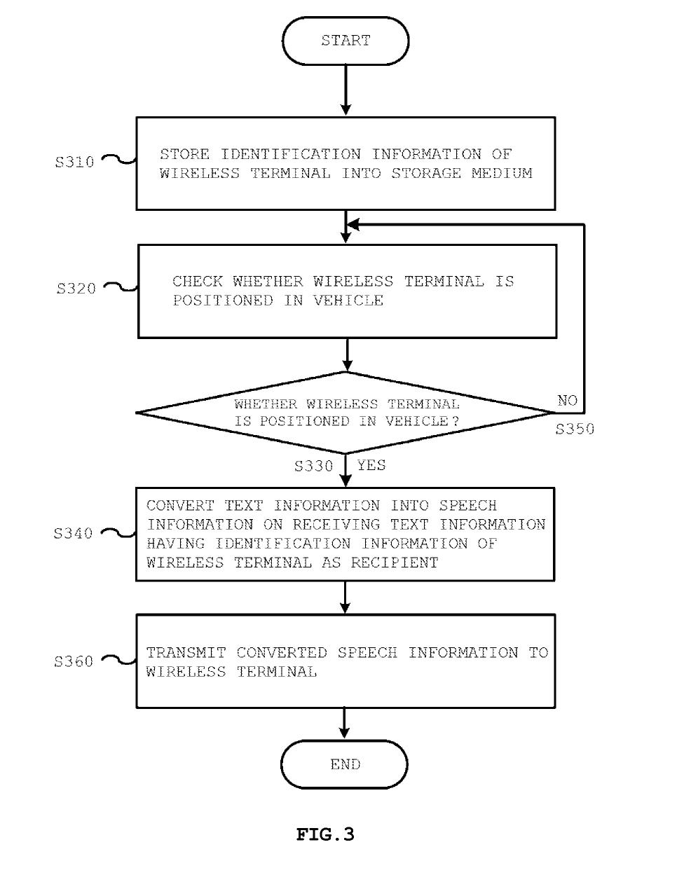

FIG. 3 shows the process for converting and outputting the text information to the speech information after checking whether the wireless terminal 100 is positioned in the vehicle according to an embodiment of the present invention.

Firstly, the information processing server 110 stores the identification information of the user's wireless terminal 100 into the storage medium 115 through the storage section 210 (S310).

Wherein, although not shown separately in the drawing, the information processing server 110 connects the identification information of the user's wireless terminal 100 and the vehicle communication apparatus 130 through the storage section 210 and further stores the connected it.

Further, the information processing server 110 converts the text information designated by the user or operator for the wireless terminal 100 into the speech information and further stores the item information to be outputted, through the storage section 210.

Since then, the information processing server 110 checks whether the wireless terminal 100 corresponding to the identification information of the wireless terminal 100 is positioned in the vehicle by the checking section 230 (S320).

The step S320 is preceded than a step S340 in the drawing, but may check whether the wireless terminal 100 corresponding to the identification information of the wireless terminal 100 is positioned in the vehicle after receiving the text information corresponding to the identification information of the wireless terminal 100 at the step S340.

When it checks whether the wireless terminal 100 is positioned in the vehicle at the step S320 (S330), the information processing server 110 converts the text information received, having the identification information of the wireless terminal 100 as the recipient, through the converting section 240 into the speech information (S340).

When it does not check whether the wireless terminal 100 is positioned in the vehicle at the step S320 (S350), the information processing server 110 repeats the step S320.

The information processing server 110 transmits the speech information converted by the converting section 240 to the wireless terminal 100 through the processing section 250 (S360).

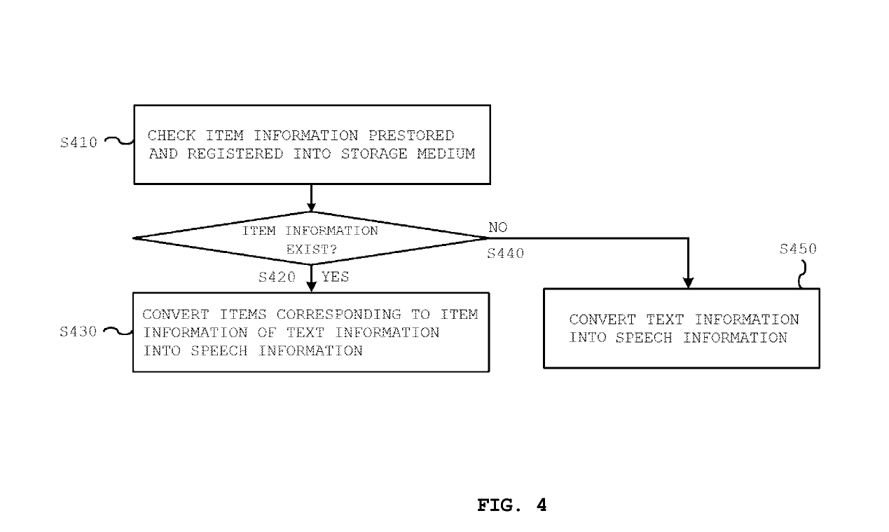

FIG. 4 shows the process for converting the text information corresponding to already-registered item information into the speech information according to an embodiment of the present invention.
FIG. 4, in more detail showing the step S340 in the FIG. 3, shows a process for a case for presetting and storing the item information to be converted into the speech information of the text information.

Firstly, when the information processing server 110 receives the text information on having the identification information of the wireless terminal 100 as the recipient, it checks whether the item information to be converted into the speech information of the text information is included in the storage medium 115 through the checking section 230 (S410).

After checking the step S410, when the item information to be converted into the speech information of the text information is included in the storage medium 115 (S420), the information processing server 110 converts items only corresponding to the checked item information of the text information into the speech information through the converting section 240 (S430).

After checking the step S410, when the item information to be converted into the speech information of the text information is not included in the storage medium 115 (S440), the information processing server 110 converts the entire text information into the speech information through the converting section 240 (S450).

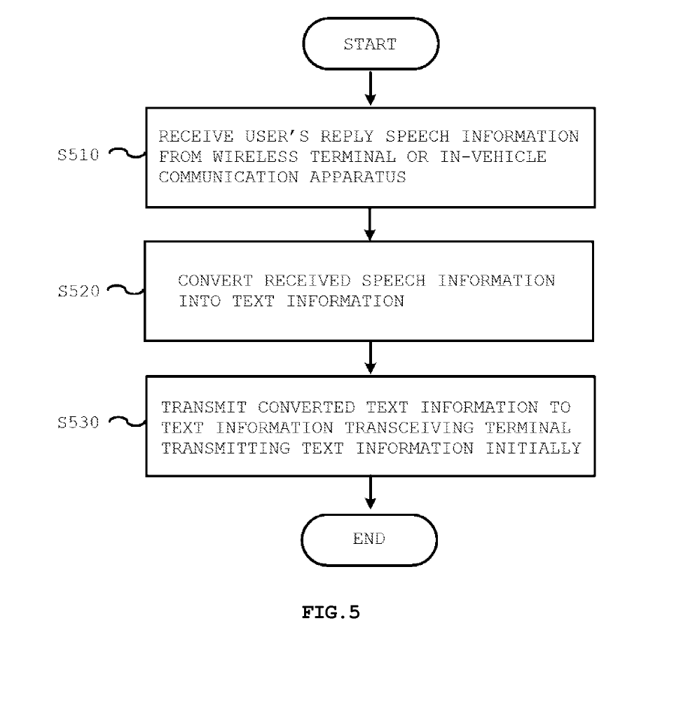

FIG. 5 shows the process for converting and transmitting a user's reply speech information into the text information according to the embodiment of the present invention.

FIG. 5 shows the process for a case in which the user for the wireless terminal 100 transmits the reply to a counterpart for the speech information, that is, the text information transceiving terminal 120 transmitting the text information.

The information processing server 110 receives the user's reply speech information through the communication section 220 and vehicle communication apparatus 130 or wireless terminal 100 (S510).

Then, the information processing server 110 converts the received speech information into the text information through the converting section 240 (S520).

The converting section 240 may convert “haha” into the special character such as “̂̂”, that is, the text information included with the emotion on converting an onomatopoeia, that is, the speech information into the text information in case of including “haha” corresponding to the onomatopoeia of the received speech information, and may differ the size of the text converted according to the size of the speech such as the onomatopoeia.

{Then, the information processing server 110 transmits the converted text information to the text information transceiving terminal 120 through the processing section 250 (S530).

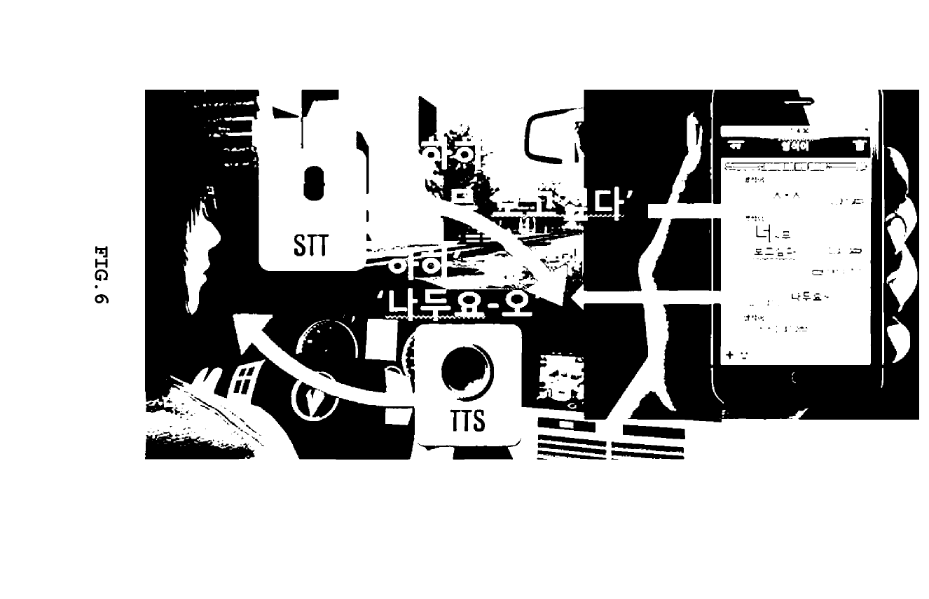

FIG. 6 shows one example according to the embodiment of the present invention.

As shown in FIG. 6, when a friend called Young-suck transmits the text information through a smartphone, the information processing server 110 checks whether the wireless terminal 100 receiving the text information is positioned in the vehicle, converts the text information into the speech information to transmit to the wireless terminal 100, and converts the reply speech information received through the wireless terminal 100 or the vehicle communication apparatus 130 into the text information to transmit to the smartphone which the Young-suck belongs to.

A second embodiment of the present invention will be described. Wherein, for the convenience of the description, the part to be overlapped with the embodiment described above will be omitted.

FIG. 1 shows the configurations of the entire communication network according to an embodiment of the present invention.

In more detail, FIG. 1 shows the configurations that an information processing system including an information processing server 110 and a storage medium 115 is connected to a user's wireless terminal 100 and a user's vehicle communication apparatus 130 through a communication network, checks whether the wireless terminal 100 is positioned in a vehicle, is connected to a text information transceiving terminal 120 for transmitting text information to the wireless terminal 100 through the communication network, receives the text information transmitted through the text information transceiving terminal 120, and converts the text information into speech information and further transmits the converted information to the vehicle communication apparatus 130, on transmitting the text information to the wireless terminal 100, when the wireless terminal 100 is positioned in the vehicle.

The information processing system in an embodiment of the present invention may have various configurations according to the embodiments and communication network connection schemes.

A key configuration of the information processing system in the present invention, that is, the information processing server 110 receives information for short-range communication connection between the wireless terminal 100 and the communication apparatus 130 from the wireless terminal 100 or the communication apparatus 130 disposed in the vehicle, or receives signals corresponding to log-in information for the wire terminal 100 from the communication apparatus 130 when the wireless terminal 100 is logged into the communication apparatus 130, or receives signals corresponding to the log-in information for the communication apparatus 130 from the wireless terminal 100 when the communication apparatus 130 is logged into the wireless terminal 100, or compares position information of the wireless terminal 100 using GPS (global positioning system) disposed in the wireless terminal 100 with the position information of the communication apparatus 130 using the GPS for the communication apparatus 130 disposed in the vehicle, checks whether the wireless terminal 100 is adjacent to the communication apparatus 130, or directly receives in-vehicle boarding information from the wireless terminal 100, directly receives vehicle boarding information for the wireless terminal 100 from the communication apparatus 130, checks whether the wireless terminal 100 is positioned in the vehicle, transmits the text information to the wireless terminal 100 on receiving the text information transmitted, having identification information (that is, including at least one of number information of the wireless terminal 100, and a user ID information in a text information transceiving application disposed in the wireless terminal 100) for the wireless terminal 100 as a recipient, through the text information transceiving terminal 120, converts the text information into speech information, and further transmits the converted text information to the vehicle communication apparatus 130.

The storage medium 115 in the present invention connects the identification information of the user's wireless terminal 100 and the identification information of the vehicle communication apparatus 130 and stores the connected it.

The user's wireless terminal 100 in the present invention, which is a receiving terminal for the text information transmitted through the text information transceiving terminal 120, receives the text information from the information processing server 110.

In the present invention, the vehicle communication apparatus 130 transmits information for checking whether the wireless terminal 100 is positioned in the vehicle to the information processing server 110, wherein information for checking whether the wireless terminal 100 is positioned in the vehicle may be at least one of the information for short-range communication connection of the wireless terminal 100, or the log-in information for the wireless terminal 100, or position information of the vehicle communication apparatus 130 using GPS (global positioning system) disposed in the vehicle communication apparatus 130, or pairing information between the Bluetooth apparatus disposed in the vehicle and the wireless terminal 100, or in-vehicle boarding information in the wireless terminal 100.

In the embodiment of the present invention, the vehicle communication apparatus 130 receives and outputs the speech information transmitted from the information processing server 110 and may transmit the inputted reply speech information to the information processing server 110 via the wireless terminal 100 or directly after receiving the user's reply speech information in some cases.

FIG. 2 shows sub-configurations of the information processing server 110 according to an embodiment of the present invention. Wherein, since the information processing server 110 according to a second embodiment of the present invention has considerably same sub-configurations as those of the information processing server 110 described in FIG. 2 earlier, the description about the part overlapped with the first embodiment described above will be omitted for the convenience of the description.

Referring to FIG. 2, the information processing server 110 in the embodiment of the present invention includes a storage section 210, a communication section 220, a checking section 230, a converting section 240, a processing section 250, and a controller 200 for controlling each configuration mentioned above.

Referring to FIG. 2, the storage section 210 connects the identification information of the user's wireless terminal 100 and the vehicle communication apparatus and stores the connected it into the storage medium 115.

Further, the storage section 210 further stores the item information, to be converted into the speech information, of the text information designated by the user or operator for the wireless terminal 100.

The communication section 220 in the embodiment of the present invention receives information, to check whether the wireless terminal 100 is positioned in the vehicle, from the wireless terminal 100 or the communication apparatus 130 through the communication network, receives the text information from the text information transceiving terminal 120 through the communication network and transmits the text information corresponding to user's reply to the text information transceiving terminal 120 in some cases, transmits the text information transmitted by the text information transceiving terminal 120 to the wireless terminal 100 through the communication network and transmits the speech information converting the text information to the vehicle communication apparatus 130, and receives a user's reply speech information through the vehicle communication apparatus 130 in some cases.

Further, the checking section 230 checks the identification information of the vehicle communication apparatus 130 connected to the identification information of the wireless terminal 100 through the storage medium and checks information for the vehicle communication apparatus 130 that will transmit the speech information converting the text information.

The processing section 250 in the present invention transmits the text information to the wireless terminal 100 through the communication section, and transmits the speech information converted through the converting section 240 to the vehicle communication apparatus 130 through the communication section 220.

Hereinafter, each information processing process in the present invention will be described in more detail.

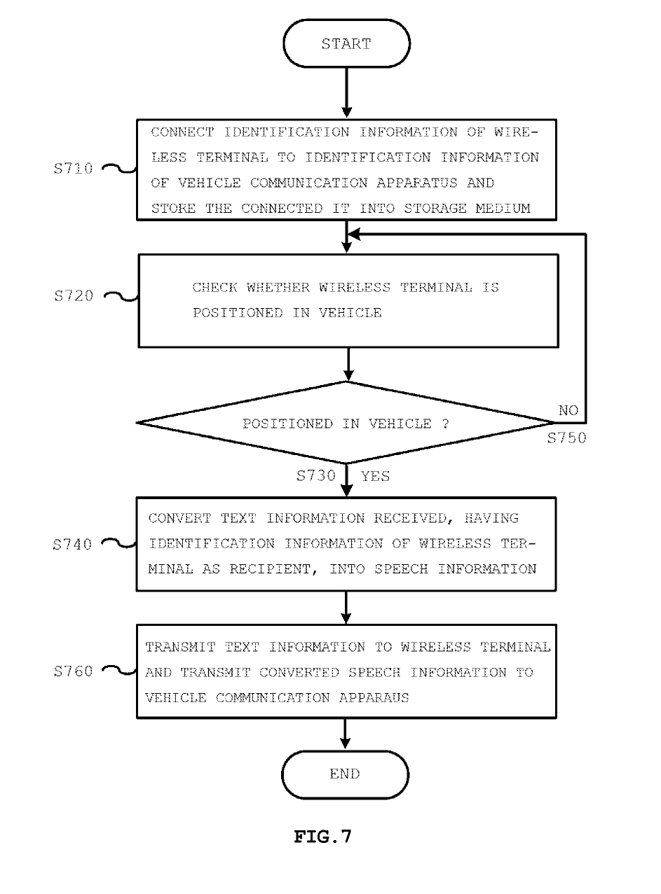

FIG. 7 shows the process for converting and outputting text information to speech information after checking whether a wireless terminal is located in a vehicle according to a second embodiment of the present invention.

Firstly, the information processing server 110 connects the identification information of the user's wireless terminal 100 and vehicle communication apparatus 130 through the storage section 210 and stores the connected it into the storage medium 115 (S710).

Further, the information processing server 110 further stores item information, to be converted into the speech information, of the text information designated by the user or operator for the wireless terminal 100 through the storage section 210.

Since then, the information processing server 110 checks whether the wireless terminal 100 corresponding to the identification information of the wireless terminal 100 is positioned in the vehicle through the communication section 230 (S720).

The step S720 is preceded than a step S340 in the drawing, but may check whether the wireless terminal 100 corresponding to the identification information of the wireless terminal 100 is positioned in the vehicle after receiving the text information corresponding to the identification information of the wireless terminal 100 at the step S740.

When it checks whether the wireless terminal 100 is positioned in the vehicle at the step S720 (S730), the information processing server 110 converts the text information received, having the identification information of the wireless terminal 100 as the recipient, through the converting section 240 into the speech information (S740).

When it does not check whether the wireless terminal 100 is positioned in the vehicle at the step S720 (S750), the information processing server 110 repeats the step S720.

The information processing server 110 transmits the text information to the wireless terminal 100 through the processing section 250, and transmits the speech information converted by the converting section 240 to the vehicle communication apparatus 130 (S760).

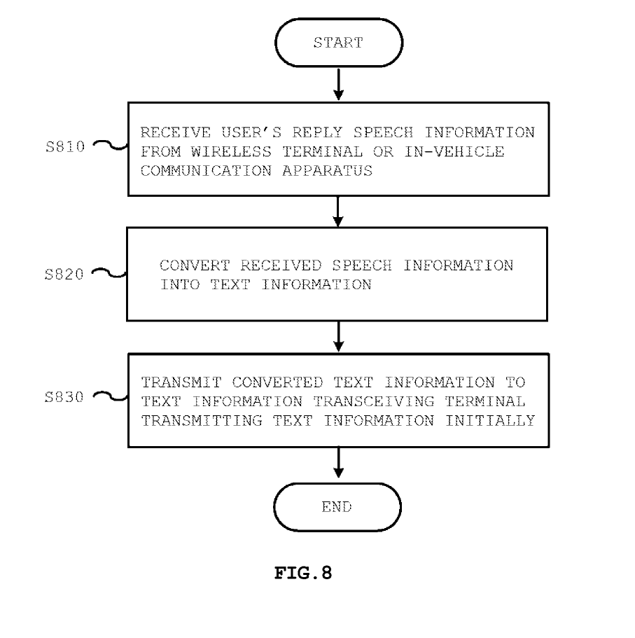

FIG. 8 shows the process for converting and transmitting a user's reply speech information into text information according to a second or third embodiment of the present invention.

FIG. 8 shows the process for a case in which the user for the wireless terminal 100 transmits the reply to a counterpart for the speech information, that is, the text information transceiving terminal 120 transmitting the text information.

The information processing server 110 receives the user's reply speech information through the communication section 220 and vehicle communication apparatus 130 (S810).

Then, the information processing server 110 converts the received speech information into the text information through the converting section 240 (S820).

The converting section 240 may convert “haha” into the special character such as “̂̂”, that is, the text information included with the emotion on converting an onomatopoeia, that is, the speech information into the text information in case of including “haha” corresponding to the onomatopoeia of the received speech information, and may differ the size of the text converted according to the size of the speech such as the onomatopoeia.

Then, the information processing server 110 transmits the converted text information to the text information transceiving terminal 120 through the processing section 250 (S830).

FIG. 6 shows one example according to the embodiment of the present invention.

As shown in FIG. 6, when a friend called Young-suck transmits the text information through a smartphone, the information processing server 110 checks whether the wireless terminal 100 receiving the text information is positioned in the vehicle, converts the text information into the speech information to transmit to the wireless terminal 100 and further transmits the converted speech information to the vehicle communication apparatus 130, and converts the reply speech information received through the vehicle communication apparatus 130 into the text information to transmit to the smartphone which the Young-suck belongs to.

A third embodiment of the present invention will be described. Wherein, for the convenience of the description, the part to be overlapped with the embodiment described above will be omitted.

FIG. 1 shows configurations of the entire communication network according to an embodiment of the present invention.

In more detail, FIG. 1 shows the configurations that an information processing system including an information processing server 110 and a storage medium 115 is connected to a user's wireless terminal 100 and a user's vehicle communication apparatus 130 through a communication network, checks whether the wireless terminal 100 is positioned in a vehicle, is connected to a text information transceiving terminal 120 for transmitting text information to the wireless terminal 100 through the communication network, receives text information transmitted through the text information transceiving terminal 120, and converts the text information into speech information and transmits the converted information to the vehicle communication apparatus 130 when the wireless terminal 130 is positioned in the vehicle.

The information processing system in an embodiment of the present invention may have various configurations according to the embodiments and communication network connection schemes.

A key configuration of the information processing system in the present invention, that is, the information processing server 110 receives information for short-range communication connection between the wireless terminal 100 and the communication apparatus 130 from the wire terminal 100 or the communication apparatus 130 disposed in the vehicle, or receives signals corresponding to log-in information for the wire terminal 100 from the communication apparatus 130 when the wire terminal 100 is logged into the communication apparatus 130, or receives signals corresponding to the log-in information for the communication apparatus 130 from the wireless terminal 100 when the communication apparatus 130 is logged into the wireless terminal 100, or compares position information of the wireless terminal 100 using GPS (global positioning system) disposed in the wireless terminal 100 with the position information of the communication apparatus 130 using the GPS for the communication apparatus 130 disposed in the vehicle, checks whether the wireless terminal 100 is adjacent to the communication apparatus 130, or directly receives in-vehicle boarding information from the wireless terminal 100, directly receives vehicle boarding information for the wireless terminal 100 from the communication apparatus 130, checks whether the wireless terminal 100 is positioned in the vehicle, converts the text information into speech information on receiving the text information transmitted, having identification information (that is, including at least one of number information for the wireless terminal 100, and a user ID information of the wireless terminal 100 in a text information transceiving application disposed in the wireless terminal 100) for the wireless terminal 100 as a recipient, through the text information transceiving terminal 120, and transmits the converted text information to the vehicle communication apparatus 130 corresponding to the identification information of the vehicle communication apparatus connected to the identification information of the wireless terminal.

The storage medium 115 in the present invention connects the identification information of the user's wireless terminal 100 and the identification information of the vehicle communication apparatus 130 and stores the connected it.

In the embodiment of the present invention, the vehicle communication apparatus 130 receives and outputs speech information transmitted from the information processing server 110 and may transmit the received reply speech information to the information processing server 110 via the wireless terminal 100 or directly after receiving the user's reply speech information in some cases.

FIG. 2 shows sub-configurations of the information processing server 110 according to an embodiment of the present invention. Wherein, since the information processing server 110 according to a third embodiment of the present invention has considerably same sub-configurations as those of the information processing server 110 described in FIG. 2 earlier, the description about the part overlapped with the first embodiment described above will be omitted for the convenience of the description.

Referring to FIG. 2, the information processing server 110 in the embodiment of the present invention includes a storage section 210, a communication section 220, a checking section 230, a converting section 240, a processing section 250, and a controller 200 for controlling each configuration mentioned above.

Referring to FIG. 2, the storage section 210 connects the identification information of the user's wireless terminal 100 and the vehicle communication apparatus 130 and stores the connected it into the storage medium 115.

Further, the checking section 230 checks the identification information of the vehicle communication apparatus 130 connected to the identification information of the wireless terminal 100 through the storage medium, and checks information for the vehicle communication apparatus 130 that will transmit the speech information converting the text information.

In addition, the processing section 250 also transmits the text information to the vehicle communication apparatus 130 through the communication section.

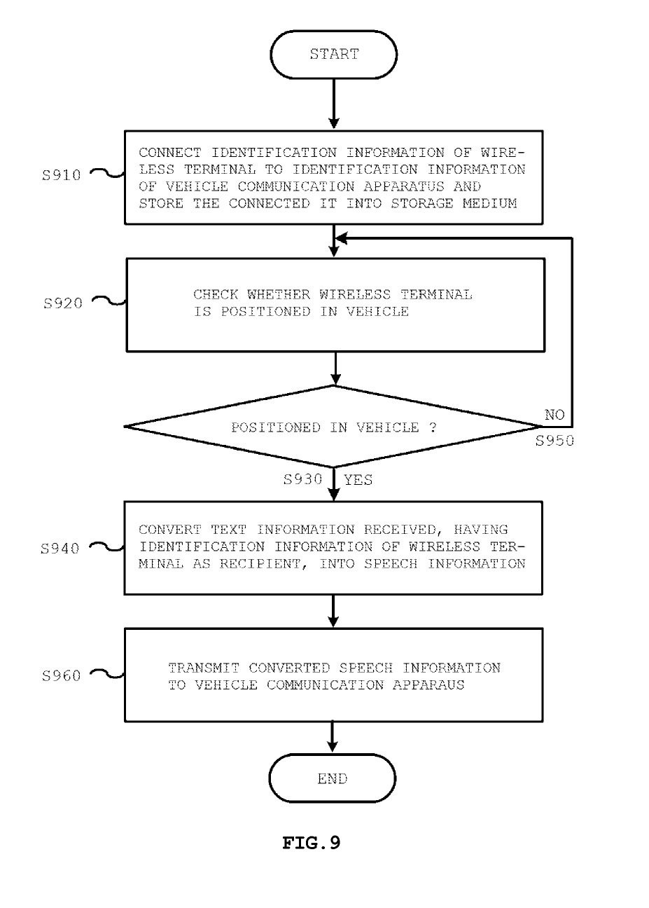

FIG. 9 shows the process for converting and outputting text information to speech information after checking whether the wireless terminal 100 is positioned in a vehicle according to an embodiment of the present invention.

Firstly, the information processing server 110 connects the identification information of the user's wireless terminal 100 and the vehicle communication apparatus 130 through the storage section 210 and stores the connected it into the storage medium 115 (S910).

Further, the information processing server 110 further stores item information, to be converted into the speech information, of the text information designated by the user or operator for the wireless terminal 100 through the storage section 210.

Since then, the information processing server 110 checks whether the wireless terminal 100 corresponding to the identification information of the wireless terminal 100 is positioned in the vehicle through the checking section 230 (S920).

The step S920 is preceded than a step S940 in the drawing, but may check whether the wireless terminal 100 corresponding to the identification information of the wireless terminal 100 is positioned in the vehicle after receiving the text information corresponding to the identification information of the wireless terminal 100 at the step S940.

When it checks whether the wireless terminal 100 is positioned in the vehicle at the step S920 (S930), the information processing server 110 converts the text information received, having the identification information of the wireless terminal 100 as the recipient, through the converting section 240 into the speech information (S940).

When it does not check whether the wireless terminal 100 is positioned in the vehicle at the step S920 (S950), the information processing server 110 repeats the step S920.

The information processing server 110 transmits the speech information converted by the converting section 240 to the vehicle communication apparatus 130 through the processing section 250 (S960).

FIG. 8 shows the process for converting and transmitting a user's reply speech information into text information according to a second or third embodiment of the present invention.

FIG. 8 shows the process for a case in which the user for the wireless terminal 100 transmits the reply to a counterpart for the speech information, that is, the text information transceiving terminal 120 transmitting the text information.

The information processing server 110 receives the user's reply speech information through the communication section 220 and vehicle communication apparatus 130 (S810).

Then, the information processing server 100 converts the received speech information into the text information through the converting section 240 (S820).

The converting section 240 may convert “haha” into the special character such as “̂̂”, that is, the text information included with the emotion on converting an onomatopoeia, that is, the speech information into the text information in case of including “haha” corresponding to the onomatopoeia of the received speech information, and may differ the size of the text converted according to the size of the speech such as the onomatopoeia.

Then, the information processing server 110 transmits the converted text information to the text information transceiving terminal 120 through the processing section 250 (S830).

FIG. 6 shows one example according to the embodiment of the present invention.

As shown in FIG. 6, when a friend called Young-suck transmits the text information through a smartphone, the information processing server 110 checks whether the wireless terminal 100 receiving the text information is positioned in the vehicle, converts the text information into the speech information to transmit to the vehicle communication apparatus 130, and converts the reply speech information received the vehicle communication apparatus 130 into the text information to transmit the converted text information to the smartphone which the Young-suck belongs to.

1. An information processing system, comprising:
a storage medium for storing identification information of a wireless terminal;
a checking section for checking whether the wireless terminal is positioned in a vehicle;
a converting section for converting text information into speech information on receiving the text information having the identification information of the wireless terminal as a recipient, in case the wireless terminal is positioned in the vehicle, according to a result of the checking by the checking section; and
a processing section for transmitting the converted speech information to the wireless terminal.

2. The information processing system according to claim 1, wherein the identification information of the wireless terminal includes at least one of number information for the wireless terminal, and a user ID information of the wireless terminal in a text information transceiving application disposed in the wireless terminal.

3. The information processing system according to claim 1, wherein the checking section receives information for short-range communication connection between the wireless terminal and the communication apparatus from the wire terminal or the communication apparatus disposed in the vehicle, or receives signals corresponding to log-in information for the wireless terminal from the communication apparatus when the wireless terminal is logged into the communication apparatus, or receives signals corresponding to the log-in information for the communication apparatus from the wireless terminal when the communication apparatus is logged into the wireless terminal, or compares position information of the wireless terminal using GPS (global positioning system) disposed in the wireless terminal with position information of the communication apparatus using the GPS for the communication apparatus disposed in the vehicle, checks whether the wireless terminal is adjacent to the communication apparatus, or directly receives in-vehicle boarding information from the wireless terminal, directly receives vehicle boarding information for the wireless terminal from the communication apparatus, and checks whether the wireless terminal is positioned in the vehicle.

4. The information processing system according to claim 1, wherein the converting section converts speech information into text information on receiving reply speech information corresponding to the text information through the wireless terminal or the communication apparatus disposed in the vehicle, and
the processing section transmits the converted text information to a text information transceiving terminal transmitting the text information, having the identification information of the wireless terminal as a recipient.

5. The information processing system according to claim 1, wherein the converting section is subdivided into a converting section (1) for converting the text information into the speech information and a converting section (2) for converting the speech information into the text information.

6. The information processing system according to claim 1, wherein the text information includes at least one of the text information received into a message transceiving application including at least one of SMS (Short Message Service), LMS (Long Message Service), MMS (Multimedia Message Services) disposed in the wireless terminal, the text information received into an e-mail transceiving application disposed in the wireless terminal, the text information received into an instant messenger application disposed in the wireless terminal, and the text information received into a SNS (Social Networking Service) application disposed in the wireless terminal.

7. An information processing method, comprising:
checking whether a wireless terminal is positioned in a vehicle;
converting text information into speech information on receiving the text information, having the identification information of the wireless terminal as a recipient, in case the wireless terminal is positioned in the vehicle, according to a result of the checking by the checking section; and
transmitting the converted speech to the wireless terminal.

8. The information processing method according to claim 7, further comprising storing the identification information of the wireless terminal into the storage medium.

9. The information processing method according to claim 7, wherein the checking receives information for short-range communication connection between the wire terminal and the communication apparatus from the wire terminal or the communication apparatus disposed in the vehicle, or receives signals corresponding to log-in information for the wireless terminal from the communication apparatus when the wireless terminal is logged into the communication apparatus, or receives signals corresponding to the log-in information for the communication apparatus from the wireless terminal when the communication apparatus is logged into the wireless terminal, or compares position information of the wireless terminal using GPS (global positioning system) disposed in the wireless terminal with position information of the communication apparatus using the GPS for the communication apparatus disposed in the vehicle, checks whether the wireless terminal is adjacent to the communication apparatus, or directly receives in-vehicle boarding information from the wireless terminal, directly receives vehicle boarding information for the wireless terminal from the communication apparatus, and checks whether the wireless terminal is positioned in the vehicle.

10. The information processing system according to claim 7, further comprising converting the speech information into text information on receiving reply speech information corresponding to the text information through the wireless terminal or the communication apparatus disposed in the vehicle, and transmitting the converted text information to a text information transceiving terminal transmitting the text information, having the identification information of the wireless terminal as a recipient.

11. A computer-readable recording medium for recording programs to execute the method of claim 7.

12-37. (canceled)
